(19) United States
(12) Patent Application Publication
(10) Pub. No.: US 2002/0130118 A1
(43) Pub. Date: Sep. 19, 2002

(54) Multi-component heating element of a thermal bonding system

(76) Inventors: Thomas W. Todd, San Diego, CA (US); Jack A. Rubin, San Diego, CA (US); Raymond J. Kusmer, Escondido, CA (US); James M. Rudden, San Diego, CA (US)

Correspondence Address: Rodney F. Brown, 3365 Baltimore Street, San Diego, CA, 92117, US

(21) Appl. No.: 10/052,584

(22) Filed: Jan. 18, 2002

Related U.S. Application Data
(60) Provisional application No. 60/277,350, filed on Mar. 19, 2001.

(51) Int. Cl. H05B 3/00

(52) U.S. Cl. 219/243; 219/552

(57) ABSTRACT

A heating element of a thermal bonding system has a body and an insert which includes the working surface of the heating element. The body is formed from a thermally and electrically conductive material and the insert is formed from a thermally conductive, but electrically insulative material. A channel runs along the exterior side of the body in alignment with the longitudinal axis of the body and the insert is press fitted into the channel to maintain a fixed interference fit between the insert and body. A heat transfer interface may also be provided between the insert and body to facilitate heat transfer therebetween.

### TECHNICAL FIELD

The present invention relates generally to thermal bonding system, and more particularly to a heating element of a thermal bonding system which includes a body formed from a thermally and electrically conductive material and an insert fitted into the body and formed from a thermally conductive, but substantially less electrically conductive material.

### BACKGROUND OF THE INVENTION

Thermal bonding is a generalized method of joining two or more workpieces together using heat. Thermal bonding methods are most applicable to workpieces which are thermally conductive and thermally stable. Thermal bonding methods commonly employ a heating element for conductive heat transfer to the workpieces and/or bonding agents.

Soldering is one such thermal bonding method which joins metallic workpieces together. The bonding agent is an electrically and thermally conductive molten metal alloy composition termed a solder. In accordance with most conventional soldering techniques, two workpieces are juxtaposed with a surface of one workpiece adjoining a surface of the other workpiece where a bond is desired. The solder and an associated flux are interposed between the adjoining surfaces of the workpieces. The flux is typically either a paste, liquid or gas and is provided for the purpose inter alia of preparing the bond surface by removing any metal oxides present at the bond surface which could otherwise disrupt the desired connection between the workpieces. Heat is conductively applied to the solder by means of a heating element, such as disclosed in U.S. Pat. No. 4,942,282, commonly termed a heater bar or hotbar. The heat is applied to the solder at a sufficient temperature and for a sufficient period of time to melt, i.e., reflow, the solder and wet both adjoining surfaces of the workpieces. Once the melted solder has wetted the adjoining surfaces, the heat is withdrawn causing the solder to cool and resolidify. The solid solder forms a fixed connection between the two workpieces, which is electrically and thermally conductive.

Die attach is a particular type of soldering which has utility to the microelectronics industry. The basic principles of soldering described above apply to die attach. However, die attach is specific to the type of workpieces being attached. In accordance with die attach, one of the workpieces is a die and the other workpiece is a substrate. The die is typically a tiny semiconductor device such as a diode, transistor or microprocessor and the substrate is typically a larger planar structure such as a printed circuit, integrated circuit package or heat sink. The die and substrate are conductively heated by direct contact between the heating element of the die attach system and one or both of the workpieces. The interposed solder, which is more specifically termed the die attach material, is melted by the conductively heated die and substrate forming an electrically and thermally conductive die attach connection between the die and the substrate.

The reliability of the connection resulting from a thermal bonding method is highly dependent on the ability of the practitioner to effectively control operation of the heating element. A common construction of the heating element, such as disclosed in U.S. Pat. No. 4,942,282, is a bar configuration having electrical terminals positioned along the length of the bar. The heating element is formed from a thermally conductive material, which is resistance heated by electric current passing through the heating element between the terminals. The practitioner controls operation of the heating element by means of a control unit, wherein the practitioner directs the control unit to adjust the level and duration of electric current supplied to the heating element with the objective of achieving a sufficient temperature for a sufficient time duration within a fixed allotted time period at the bond surface to entirely melt the solder and properly form the connection.

A stable heating step during the thermal bonding process minimizes the risk of thermal damage to delicate workpieces and maximizes the probability of achieving a reliable connection. However, prior art thermal bonding systems often lack sufficient control to satisfactorily stabilize the heating step. In particular, prior art thermal bonding systems are often unable to predictably achieve a desired temperature at the bond surface, which may in part be attributed to unsatisfactory performance of the heating element. For example, the working surface of the heating element contacting the workpiece may not provide a uniform temperature along its entire length, particularly if the heating element has a relatively extended length, which results in non-uniform heat transfer between the heating element and the bond surface. Temperature irregularities along the length of the heating element can be caused by chemical and/or thermal degradation of the working surface due to prolonged high-temperature contact with a varied range of bonding agents which may be used in the thermal bonding process, such as solders, fluxes, adhesives and others. Moreover, the working surface of many prior art heating elements are electrically conductive. Consequently a portion of the electrical energy flowing through the heating element is conducted away from the bond surface out into the workpiece, which is likewise typically electrically conductive. As a result, heat is correspondingly diverted away from the bond surface into the workpiece, thereby destabilizing the heating step. Unsatisfactory performance of the heating element produces an inordinate number of failures during operation of prior art thermal bonding systems, either thermally damaging the workpieces or insufficiently completing the connection.

The present invention recognizes a need for a cost-effective heating element which enables a stable heating step during a thermal bonding process, thereby achieving a reliable connection. Accordingly, it is an object of the present invention to provide a heating element of a thermal bonding system which has satisfactory performance characteristics, thereby contributing to the stability of the heating step during the thermal bonding process. More particularly, it is an object of the present invention to provide a heating element, which reduces the amount of electrical energy conducted to the workpiece via the heating element. It is another object of the present invention to provide a heating element which exhibits substantial temperature uniformity over the entire length of its working surface. It is yet another object of the present invention to provide a heating element having a working surface, which is substantially resistant to chemical or thermal degradation caused by high-temperature contact with a broad range of bonding agents. It is still another object of the present invention to provide a relatively cost-effective method for fabricating a heating element satisfying the above-recited objectives. These objects and others are accomplished in accordance with the invention described hereafter.

### SUMMARY OF THE INVENTION

The present invention is a heating element for a thermal bonding system comprising a body and an insert. The body has an exterior side with a channel formed therein, which is aligned with the longitudinal axis of the body. The channel has a base face and first and second lateral faces, which extend from opposing edges of the base face, to enclose the channel on three sides. The remaining sides of the channel are open. The insert has a bar configuration, which includes a working surface, base face, and first and second lateral faces. The base face and first and second lateral faces of the insert are configured in correspondence with the base face and first and second lateral faces of the channel, respectively. The insert is positioned in the channel such that the base faces of the insert and channel are aligned with one another and further such that the first and second lateral faces of the insert and channel are aligned with one another. The width of the channel and the width of the insert are substantially equal so that an interference fit is maintained between the insert and body. The length of the exterior side of the body, the length of the channel, and the length of the insert are all likewise substantially equal. However, the depth of the channel is substantially less than the height of the insert, which is defined as the distance between the base face and the working surface, so that the working surface extends from the channel and is exposed to the exterior.

The body is formed from a first material and the insert is formed from a second material, which is distinct from the first material. Although the first and second materials are both substantially thermally conductive, the first material is substantially more electrically conductive than the second material. In other words, the first material has a substantially greater electrical conductivity and conversely a substantially lower electrical resistivity than the second material. The first material is an electrically conductive metal or non-metal. A preferred electrically conductive first material is selected from a group of metals consisting of titanium, stainless steel, tungsten, molybdenum, iron, nickel, chromium, cobalt and alloys thereof. A more preferred electrically conductive first material is selected from a group of metals consisting of pure titanium and titanium alloys. Alternatively, a preferred electrically conductive first material is graphite, a non-metal. The second material is a ceramic or a gemstone. The second material is preferably selected from a group consisting of aluminum nitride, aluminum oxide, beryllium oxide, silicon carbide, silicon nitride, boron nitride, magnesium oxide, spinel, sapphire, diamond and mixtures thereof. More preferably, the second material is aluminum nitride. By selecting first and second materials having the above-recited properties, the conduction of thermal energy from the body through the insert is facilitated, while the conduction of electrical energy from the body through the insert is inhibited in the present construction of the heating element.

In accordance with one embodiment of the heating element, the faces of the insert are in substantially continuous tight-fitting contact with the faces of the channel. In accordance with an alternate embodiment of the heating element, a heat transfer interface formed from a thermally conductive third material is positioned in the channel between the body and the insert to contact the body and insert. The heat transfer interface is formed from a thin sheet of the third material or as a thin coating of the third material on the body or insert. The third material is a ductile metal and preferably is a ductile metal selected from a group consisting of copper, silver, gold, aluminum, nickel, platinum, palladium, tin, tantalum, lead, indium, bismuth, and alloys thereof, including brazing compounds. More preferably, the third material is copper. In accordance with one embodiment, the heat transfer interface is configured as three planar segments which correspond to the base face and the first and second lateral faces of the channel, respectively.

The present invention is further a method of fabricating a heating element for a thermal bonding system. The method comprises providing a body and an insert having the same properties as described above and press fitting the insert into the channel with the working surface exposed. The insert is maintained fixed in the channel by an interference fit. The method may further comprise positioning a heat transfer interface, which has the above-recited properties, between the insert and body to facilitate heat transfer therebetween.

The invention will be further understood from the accompanying drawings and description.

### BRIEF DESCRIPTION OF THE DRAWINGS

FIG. 1 is a schematic view of a representative thermal bonding system employing a heating element of the present invention.

FIG. 2 is an elevational view of an embodiment of a heating element of the present invention.

FIG. 3 is an exploded perspective view of the heating element of FIG. 2.

FIG. 4 is a partial cross sectional view of the heating element of FIG. 2 taken along line 4-4.

FIG. 5 is an exploded perspective view of an alternate embodiment of a heating element of the present invention.

FIG. 6 is a partial cross sectional view of the heating element of FIG. 5 which corresponds to the view of FIG. 4.

### DESCRIPTION OF PREFERRED EMBODIMENTS

The heating element of the present invention is described below with reference to a specific type of thermal bonding system and thermal bonding method, i.e., a soldering system and a soldering method. It is understood, however, that the present heating element is not limited to application in any specific type of thermal bonding system or thermal bonding method. As is readily apparent to the skilled artisan from the teaching herein, the present heating element is generally applicable to any number of types of thermal bonding systems and thermal bonding methods.

A soldering system employing a heating element of the present invention is shown schematically with reference to FIG. 1 and generally designated 10. The soldering system 10 includes a heating unit 12, a control unit 14, a computer 16 and a workpiece handler 18. A heating unit communication link 20 extends from the control unit 14 to the heating unit 12 and a computer communication link 22 extends from the control unit 14 to the computer 16. The computer 16 is preferably a conventional programmable desktop computer having a processor, memory and user interfaces.

The control unit 14 contains circuitry, which enables performance of the desired control functions for the soldering system 10. For example, the control unit 14 may contain circuitry substantially similar to the control circuitry described in U.S. Pat. No. 5,260,548, incorporated herein by reference, but specifically adapted to function in cooperation with the communication links 20, 22 as an interface between the computer 16 and the heating unit 12. As such, operating instructions programmed into the computer 16 are communicated from the computer 16 to the heating unit 12 via the control unit 14.

The workpiece handler 18 may be substantially any conventional handler capable of retaining and transporting workpieces (not shown) to and from the heating unit 12 along a handler pathway 24. The workpiece handler 18 preferably has a structure, which is adaptively configured to cooperate with corresponding structures in the heating unit 12 in the performance of these functions. As such, the workpiece handler 18 is desirably configured to deliver the workpieces to a work station 26 of the heating unit 12 and withdraw the workpieces from the work station 26 upon completion of the soldering process. In accordance with certain embodiments, the workpiece handler 18 may also function alone or in cooperation with elements of the heating unit 12 to retain the workpieces in their required relative positions at the work station 26 while the workpieces are being attached.

The heating unit 12 comprises the work station 26, an electric power supply 28, and a heating element 30. The work station 26 is a chamber having a handler port 32, which provides the workpiece handler 18 with access to the work station 26 for the delivery of workpieces to the work station 26 and the withdrawal of workpieces from the work station 26. The heating element 30 is positioned within the work station 26. First and second terminals 34, 36 are electrically coupled with the heating element 30 and are in electrical communication with the electric power supply 28 via first and second electrical leads 38, 40, respectively. The output of the electric power supply 28 is regulated by the control unit 14, which communicates output instructions directly to the electric power supply 28 via the heating unit communication link 20.

Although not shown in the present conceptualized representation of the soldering system 10, it is within the purview of the skilled artisan to provide the soldering system 10 with additional structure for the performance of desired functions of the soldering process. For example, means may be provided within the soldering system 10 for maintaining a vacuum against the workpieces in the work station 26, wherein the vacuum retains the workpieces in place while they are being connected. Means may also be provided within the soldering system 10 for feeding a gas flux to the work station 26 as an alternative to conventional paste or liquid fluxes. It is also noted that the present heating element 30 employs only two terminals 34, 36. This design is termed a single hoop design. It is within the scope of the present invention and the purview of the skilled artisan to adapt the teaching of the present heating element 30 to a multiple hoop design, wherein parallel circuits and added terminals are employed to enable elongated heating elements.

It is further understood that the above-recited soldering system 10 is a generalized illustration of a soldering system within which the heating element 30 of the present invention can be employed. A die attach system is an example of a specific type of soldering system, and more generally, an example of a specific type of thermal bonding system, in which the present heating element has specific utility. Accordingly, when the broader terms “solder” and “soldering” are used herein, it is understood that these terms are inclusive of the specific terms “die attach material” and “die attach” unless expressly stated otherwise herein.

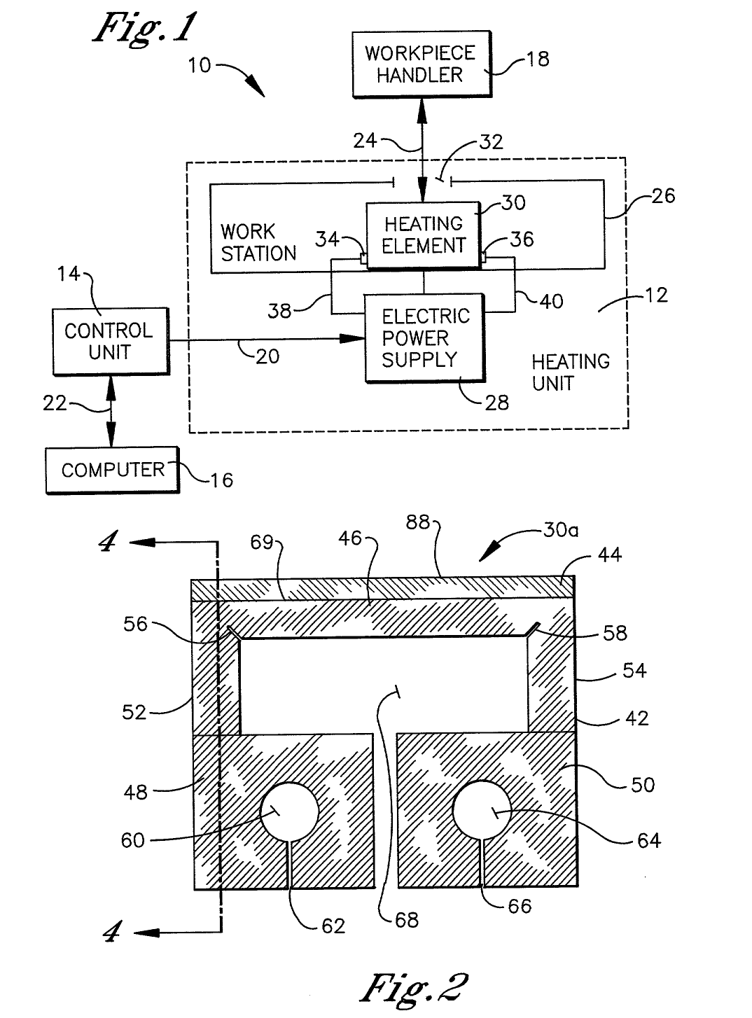

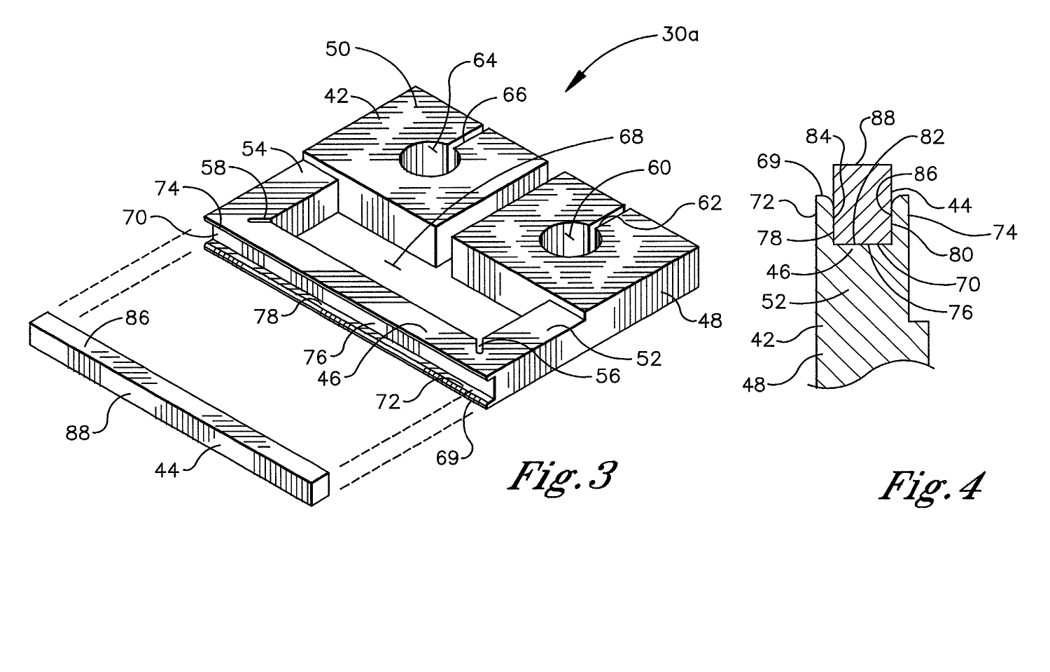

Referring to FIGS. 2-4, one embodiment of a heating element of the present invention is shown and generally designated 30a. The heating element 30a has a body 42 and an insert 44, which are two separate discrete components mechanically joined together in a manner described hereafter. The body 42 is a unitary structure having a transverse member 46 and first and second terminal members 48, 50. The transverse member 46 is configured generally in the shape of a bar and the first and second terminal members are configured generally in the shape of square blocks. The first and second terminal members 48, 50 are connected to the transverse member 46 by first and second connective members 52, 54, which extend from opposite ends of the transverse member 46 in a substantially perpendicular orientation relative to the longitudinal axis of the transverse member 46. A first resistance slit 56 is provided at the junction of the transverse member 46 and first connective member 52. A second resistance slit 58 is similarly provided at the junction of the transverse member 46 and second connective member 54. The first and second resistance slits 56, 58 enhance the heat generating capability of the body 42 and maintain the thermal balance of the body 42 by providing increased resistance at their points of placement.

A first terminal aperture 60 and first terminal slit 62 are formed through the first terminal member 48 to receive and retain the first terminal 34 therein. A second terminal aperture 64 and second terminal slit 66 are similarly formed through the second terminal member 50 to receive and retain the second terminal 36 therein. The interior sides of the transverse member 46, first and second terminal members 48, 50, and first and second connective members 52, 54 define the boundaries of an interior opening 68 extending through the center of the body 42 and between the first and second terminal members 48, 50 out the side of the body 42 opposite the transverse member 46. Accordingly, electrical and thermal conductivity between the first and second terminal members 48, 50 is only enabled via a continuous conductive pathway through the first connective member 52, transverse member46, and second connective member 54, in series.

The transverse member 46 has an exterior side 69, along substantially the entire length of which a channel 70 extends. The channel 70 is defined by first and second rails 72, 74, which extend substantially parallel to one another on opposite edges of the exterior side 69. The channel 70 has three external faces, a base face 76 and first and second lateral faces 78, 80. The channel faces 76, 78, 80 are precision formed to be straight and flat. The first and second lateral faces 78, 80 are oriented at precise right angles to the base face 76. The insert 44 is configured generally in the shape of a bar. The insert 44 has a plurality of external faces including a base face 82 and first and second lateral faces 84, 86. The insert faces 82, 84, 86 correspond in straightness, flatness and relative angularity to the channel faces 76, 78, 80, respectively. The insert 44 is also dimensioned to be received by the channel 70. In particular, the width of the insert 44 is sized substantially equal to the width of the channel 70, which causes fixable retention of the insert 44 within the channel 70 in tight interference-fitted relationship with the first and second rails 72, 74. As such, the base face 82 and first and second lateral faces 84, 86 of the insert 44 are in tight substantially continuous contact with the base face 76 and first and second lateral faces 78, 80 of the channel 70, respectively.

The length of the insert 44 is substantially equal to the length of the channel 70 and correspondingly substantially equal to the length of the transverse member 46. The height of the insert 44 is greater than the depth of the channel 70 and correspondingly greater than the height of the first and second rails 72, 74. As a result a portion of the insert 44 extends externally out from the channel 70 and away from the exterior side 69 of the transverse member 46 to provide the heating element 30a with an exposed working surface 88. The position of the insert 44 relative to the body 42 allows only the working surface 88 to contact a workpiece during the soldering process, while preventing contact between the body 42 and the workpiece.

The exact dimensions of the body 42 and insert 44 are generally selected as a function of the particular soldering application to be practiced. The dimensions of the body 42 and insert 44 are preferably selected in direct correspondence with the size of the workpiece being soldered. Therefore, the heating element of the present invention is not limited to any specific dimensions. Nevertheless, the dimensions of an exemplary heating element are recited below for purposes of illustration:

### Dimensions of an Exemplary Heating Element

first terminal member width=second terminal member width=0.125 inches

first connective member width=second connective member width=0.109 inches

insert length=channel length=transverse member length=1.000 inch

insert width=channel width=0.079 inches

insert height=0.050 inches

first rail height=second rail height=channel depth=0.030 inches

extension distance of insert above first and second rails=0.020 inches

In addition to differences in their structural configuration, the body 42 and insert 44 also differ in the composition and properties of the materials from which they are formed. In general, both the body 42 and the insert 44 are deemed more thermally conductive than thermally insulative. However, the body 42 is deemed more electrically conductive than electrically insulative while the insert 44 is deemed more electrically insulative than electrically conductive.

The body 42 is integrally formed from a first material and the insert 44 is integrally formed from a second material, which is distinct from the first material. Although the thermal conductivities of the first and second materials are not necessarily equal, both the first and second materials have sufficient thermal conductivity values to render both materials more thermally conductive than thermally insulative. Specifically, both the first and second materials have thermal conductivities preferably greater than about 0.1 Watt/meter-K, more preferably greater than about 1 Watt/meter-K, and most preferably greater than about 5 Watt/meter-K. However, the first and second materials have substantially different electrical conductivities. Specifically, the first material has a greater electrical conductivity than the second material such that the first material is electrically conductive, while the second material is electrically insulative. The relationship between the electrical conductivities of the first and second materials may be quantitatively expressed in terms of electrical resistivity which is essentially the inverse of electrical conductivity. Thus, the first material is characterized as having a lower electrical resistivity than the second material. The first material has an electrical resistivity preferably less than about 1 ohm-cm, more preferably less than about 1×10⁻² ohm-cm, and most preferably less than about 2×10⁻⁴ ohm-cm. By comparison, the second material has an electrical resistivity preferably greater than about 1×10⁵ ohm-cm, more preferably greater than about 1×10⁷ ohm-cm, and most preferably than about 1×10⁹ ohm-cm. Consequently, the heating element 30a facilitates the conduction of thermal energy from the body 42 to a workpiece via the insert 44, while inhibiting the conduction of electrical energy from the body 42 to the workpiece via the insert 44.

A number of alternatives for the first and second materials satisfying the above-recited criteria are available within the scope of the present invention. First materials having utility herein are generally characterized as electrically conductive metals or non-metals. A preferred electrically conductive non-metal is graphite. A preferred electrically conductive metal is selected from a group consisting of titanium, stainless steel, tungsten, molybdenum, iron, nickel, chromium, cobalt and alloys thereof. Preferred alloys include iron-nickel, iron-nickel-cobalt, iron-chromium, and nickel-chromium. A more preferred first material is a commercially pure grade of titanium or an alloy of titanium such as Ti 64 or Ti 6242. A most preferred first material is the titanium alloy Ti 6242. Ti 6242 is advantageous because of its ready availability, relatively low electrical resistivity (i.e., high electrical conductivity), high thermal conductivity, high chemical resistance and favorable high-temperature mechanical properties. In particular, Ti 6242 typically has a thermal conductivity of about 6 Watt/meter-K, which renders it more thermally conductive than thermally insulative. Furthermore, Ti 6242 typically has an electrical resistivity of about 2×10⁻⁴ ohm-cm, which renders it more electrically conductive than electrically insulative.

Second materials having utility herein are generally characterized as ceramics or gemstones. The term gemstones is inclusive of industrial grade natural and synthetic gemstones. A preferred second material is selected from a group consisting of aluminum nitride, aluminum oxide, beryllium oxide, silicon carbide, silicon nitride, boron nitride, magnesium oxide, spinel, sapphire, diamond and mixtures thereof. A more preferred second material is aluminum nitride. Aluminum nitride is advantageous because of its ready commercial availability, high thermal conductivity, high electrical resistivity (i.e., low electrical conductivity) high hardness, chemical inertness, and non-toxicity. In particular, aluminum nitride typically has a thermal conductivity in a range from about 70 to 250 Watt/meter-K, which, like Ti 6242, renders aluminum nitride more thermally conductive than thermally insulative. Furthermore, aluminum nitride typically has an electrical resistivity in a range from about 1×10⁹ to 1×10¹⁹ ohm-cm, which is substantially greater than the electrical resistivity of Ti 6242. Thus, aluminum nitride is substantially less electrically conductive than Ti 6242, rendering aluminum nitride more electrically insulative than electrically conductive.

As a rule, the first and second materials are selected to compliment one another during operation of the soldering system 10. For example, it is desirable that both materials exhibit somewhat similar coefficients of thermal expansion so they expand and contract at somewhat similar rates during operation of the soldering system 10. This reduces the probability that the insert 44 will separate from the body 42 or that the heating element 30a is otherwise damaged due to temperature cycling of the heating element 30a during operation. As such, the coefficient of thermal expansion for Ti 6242 is typically about 9 ppm/K while the coefficient of thermal expansion for aluminum nitride is typically about 6 ppm/K.

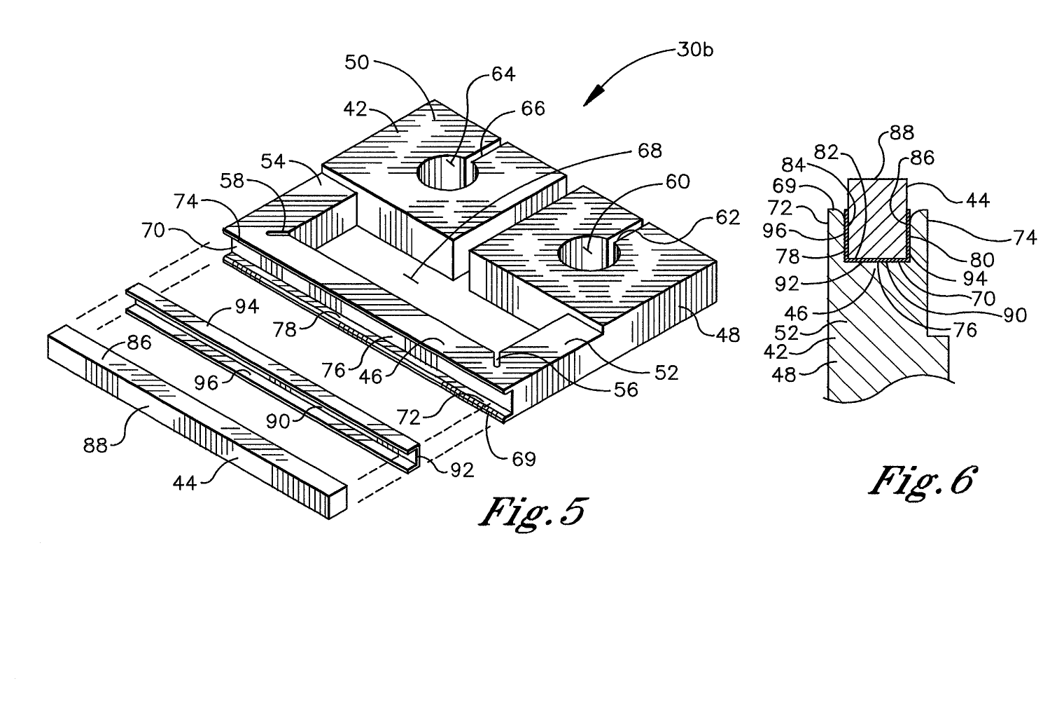

Referring to FIGS. 5 and 6, an alternate embodiment of a heating element of the present invention is shown and generally designated 30b. Structural features of the heating element 30b, which are common to the heating element 30a, are designated by the same reference characters in FIGS. 5 and 6 as in FIGS. 2-4. The heating element 30b is substantially the same as the heating element 30a except for the addition of a third discrete component to the heating element 30b in combination with the body 42 and the insert 44. In particular, the heating element 30b additionally consists of a discrete heat transfer interface 90 formed from a thin sheet of thermally conductive material which is positioned between the channel faces 76, 78, 80 and the insert faces 82, 84, 86, respectively. The heat transfer interface 90 is configured as three planar segments, a base segment 92 and first and second lateral segments 94, 96, by folding or other means. The interface segments 92, 94, 96 are configured in correspondence with the base face 76 and first and second lateral faces 78, 80 of the channel 70, respectively. As such, the dimensions of the interface segments 92, 94, 96 are substantially identical to those of the corresponding channel faces 76, 78, 80.

The heat transfer interface 90 is very thin relative to the body 42 and insert 44. For example, the heat transfer interface 90 may have a thickness in a range from about 5×10⁻⁴ to 5×10⁻³ inches. The heat transfer interface 90 functions as an interface between the body 42 and insert 44, preventing direct contact between the channel faces 76, 78, 80 and the insert faces 82, 84, 86 when the heat transfer interface 90 is fitted around the insert 44 within the channel 70. The material, from which the heat transfer interface 90 is formed, is a third material, which is distinct from the second material, and which is preferably distinct from the first material. The third material, like the first and second materials, is more thermally conductive than thermally insulative, having a thermal conductivity preferably greater than about 0.1 Watt/meter-K, more preferably greater than about 1 Watt/meter-K, and most preferably greater than about 5 Watt/meter-K up to about 2500 Watt/meter-K. However, the heat transfer interface 90 formed from the third material is highly ductile as compared to the body 42 and insert 44 formed from the first and second materials, respectively, which are relatively rigid. Third materials having utility herein are generally characterized as ductile metals, which are typically electrically conductive in the manner of the first material. A preferred third material is selected from a group consisting of copper, silver, gold, aluminum, nickel, platinum, palladium, tin, tantalum, lead, indium, bismuth, and alloys thereof. Among the preferred alloys are brazing compounds, which include copper-silver/titanium, gold-tin, tin-lead, indium-tin, and bismuth-tin. A most preferred third material is copper.

Although the heating element 30b is not limited to a particular mechanism of operation, the heat transfer interface 90 is believed to enhance the performance of the heating element 30b by facilitating heat transfer between the body 42 and the insert 44. In particular, the highly ductile heat transfer interface 90 is believed to fill any micro-discontinuities, which may occur in the surface of the channel faces 76, 78, 80 and insert faces 82, 84, 86 upon compression of the insert 44 against the body 42.

In alternate embodiments of the present invention not shown, the heat transfer interface may be configured as a single planar segment corresponding to either the base segment 92, the first lateral segment 94, or the second lateral segment 96, or configured as two planar segments corresponding to the base and first lateral segments 92, 94 or the base and second lateral segments 92, 96 of the heat transfer interface 90. The alternate configurations of the heat transfer interface are fitted between the respective corresponding faces of the channel and insert to prevent contact between the faces, while facilitating heat transfer between the faces. Of the above-recited alternate embodiments, a preferred alternate configuration of the heat transfer interface is a single planar segment corresponding to the base segment 92 of the heat transfer interface 90, which is fitted between the channel base face 76 and the insert base face 82.

In yet other alternate embodiments of the present invention not shown, the heat transfer interface may be a discrete coating of the third material, which has been applied in a conventional manner to one or more of the channel faces 76, 78, 80 and/or one or more of the insert faces 82, 84, 86. Where the heat transfer interface is a coating of the third material rather than a sheet as described above, it is typically thinner than the sheet. Nevertheless, the coating is intended to perform in substantially the same manner as the sheet.

### Method of Fabrication

A general method of fabricating the heating element 30a is described hereafter with continuing reference to FIGS. 2-4. The initial configuration of the body 42 is constructed from the first material by any conventional means well known to those skilled in the art. A preferred technique for creating the channel 70 in the transverse member 46 is electrical discharge machining which produces the desired channel configuration with a high degree of precision to achieve a beneficial surface finish. Conventional machining techniques such as milling may also be used to create the channel 70 if the required precision and surface finish can be achieved. Where the second material, from which the insert 44 is fabricated, is a ceramic, a raw stock ceramic can be formed by any number of known techniques such as sintering, hot pressing, tape casting, hot isostatic pressing, single crystal growth and the like. The resulting raw stock ceramic or a gemstone, if it is used in the alternative, can be precision shaped to the desired insert configuration by diamond sawing and grinding operations. Alternatively, a ceramic insert can be constructed by a net-shape method such as pressing-and-sintering or injection molding. The insert 44 is mechanically joined with the body 42 by press fitting the insert 44 into the channel 70 such that the first and second rails 72, 74 are in stressed engagement with the first and second lateral faces 84, 86 of the insert 44 to fixably retain the insert 44 in an interference fit within the channel 70 throughout the useful life of the heating element 30a. Mechanical joining of the insert 44 and the body 42 avoids other more costly and time-consuming bonding techniques such as soldering or brazing. Furthermore, mechanical joining obviates the need for supplemental bonding materials, such as solder, adhesives or the like, to effect joinder of the insert 44 and body 42 and obviates the need to thermally or chemically treat the bond site to effect joinder.

Fabrication of the heating element 30b is performed in substantially the same manner as described above with respect to the heating element 30a. However, referring to FIGS. 5 and 6, the heat transfer interface 90 having a segmented sheet-like configuration is placed in the channel 70 to substantially cover the base face 76 and first and second lateral faces 78, 80 of the channel 70 before the insert 44 is press fitted into the channel 70. Alternatively, the heat transfer interface 90 is fitted over the insert 44 to substantially cover the base face 82 and cover at least in part the first and second lateral faces 84, 86 of the insert 44 before the insert 44 is press fitted into the channel 70. In either case, it is noted that the heat transfer interface 90 is preferably free from any supplemental adhesives. The heat transfer interface 90 is maintained in its desired position solely by compression of the insert faces 82, 84, 86 against the respective corresponding channel faces 76, 78, 80. Where the heat transfer interface alternatively has a coating configuration, the coating is applied to the desired face or faces of the insert 44 or channel 70 by a selected conventional coating technique before the insert 44 is mechanically joined with the body 42.

While the forgoing preferred embodiments of the invention have been described and shown, it is understood that alternatives and modifications, such as those suggested and others, may be made thereto and fall within the scope of the invention.

We claim:

1. A heating element for a thermal bonding system comprising:
a body formed from a first material, said body having an exterior side with a channel formed in said exterior side; and
an insert formed from a second material and having a working surface, said insert positioned in said channel with said working surface exposed and said insert maintained in said channel by an interference fit, wherein said first material is substantially more electrically conductive than said second material.

2. The heating element of claim 1, wherein said body has a longitudinal axis and said channel is aligned with said longitudinal axis.

3. The heating element of claim 1, wherein said channel has a width and said insert has a width, wherein said width of said channel and said width of said insert are substantially equal.

4. The heating element of claim 1, wherein said channel has a depth and said insert has a height, wherein said depth of said channel is substantially less than said height of said insert.

5. The heating element of claim 1, wherein said first and second materials are both substantially thermally conductive.

6. The heating element of claim 1, wherein said first material is a metal.

7. The heating element of claim 1, wherein said first material is an electrically conductive non-metal.

8. The heating element of claim 1, wherein said first material is selected from a group consisting of titanium, stainless steel, tungsten, molybdenum, iron, nickel, chromium, cobalt, alloys thereof, and graphite.

9. The heating element of claim 1, wherein said first material is pure titanium or a titanium alloy.

10. The heating element of claim 1, wherein said second material is a ceramic or a gemstone.

11. The heating element of claim 1, wherein said second material is selected from a group consisting of aluminum nitride, aluminum oxide, beryllium oxide, silicon carbide, silicon nitride, boron nitride, magnesium oxide, spinel, sapphire, diamond and mixtures thereof.

12. The heating element of claim 1, wherein said second material is aluminum nitride.

13. The heating element of claim 1, wherein said first material has an electrical resistivity less than about 1 ohm-cm.

14. The heating element of claim 1, wherein said second material has an electrical resistivity greater than about 1×10⁵ ohm-cm.

15. The heating element of claim 1, wherein said first and second materials each have a thermal conductivity greater than about 0.1 Watt/meter-K.

16. A heating element for a thermal bonding system comprising:
a body formed from a first material, said body having an exterior side with a channel formed in said exterior side;
an insert formed from a second material and having a working surface, said insert positioned in said channel with said working surface exposed and said insert maintained in said channel by an interference fit, wherein said first material is substantially more electrically conductive than said second material; and
a heat transfer interface formed from a third material and positioned in said channel between said body and said insert to contact said body and said insert, wherein said heat transfer interface is thermally conductive.

17. The heating element of claim 16, wherein said heat transfer interface is formed from a sheet of said third material.

18. The heating element of claim 16, wherein said heat transfer interface is a coating of said third material on said insert or said body.

19. The heating element of claim 16, wherein said heat transfer interface is configured as three planar segments in correspondence with a base face of said channel and opposing first and second lateral faces extending from said base face of said channel.

20. The heating element of claim 16, wherein said first material is a metal.

21. The heating element of claim 16, wherein said first material is an electrically conductive non-metal.

22. The heating element of claim 16, wherein said first material is selected from a group consisting of titanium, stainless steel, tungsten, molybdenum, iron, nickel, chromium, cobalt, alloys thereof, and graphite.

23. The heating element of claim 16, wherein said second material is a ceramic or a gemstone.

24. The heating element of claim 16, wherein said second material is selected from a group consisting of aluminum nitride, aluminum oxide, beryllium oxide, silicon carbide, silicon nitride, boron nitride, magnesium oxide, spinel, sapphire, diamond and mixtures thereof.

25. The heating element of claim 16, wherein said third material is selected from a group consisting of copper, silver, gold, aluminum, nickel, platinum, palladium, tin, tantalum, lead, indium, bismuth, and alloys thereof.

26. The heating element of claim 16, wherein said third material is a brazing compound.

27. The heating element of claim 16, wherein said third material is copper.

28. The heating element of claim 16, wherein said first, second and third materials each have a thermal conductivity greater than about 0.1 Watt/meter-K.

29. The heating element of claim 16, wherein said first material has an electrical resistivity less than about 1 ohm-cm.

30. The heating element of claim 16, wherein said second material has an electrical resistivity greater than about 1×10⁵ ohm-cm.

31. A method of fabricating a heating element for a thermal bonding system comprising:
providing a body formed from a first material, said body having an exterior side with a channel formed in said exterior side and said channel having a width;
providing an insert formed from a second material and having a working surface and a width, wherein said width of said insert is substantially equal to said width of said channel and wherein said first material is substantially more electrically conductive than said second material; and
press fitting said insert into said channel with said working surface exposed, wherein said insert is maintained in said channel by an interference fit.

32. The method of claim 31, further comprising positioning a heat transfer interface formed from a third material in said channel between said insert and said body, wherein said heat transfer interface is substantially thermally conductive.

33. The method of claim 31, wherein said first material is selected from a group consisting of titanium, stainless steel, tungsten, molybdenum, iron, nickel, chromium, cobalt, alloys thereof, and graphite.

34. The method of claim 31, wherein said second material is selected from a group consisting of aluminum nitride, aluminum oxide, beryllium oxide, silicon carbide, silicon nitride, boron nitride, magnesium oxide, spinel, sapphire, diamond and mixtures thereof.

35. The method of claim 31, wherein said third material is selected from a group consisting of copper, silver, gold, aluminum, nickel, platinum, palladium, tin, tantalum, lead, indium, bismuth, and alloys thereof.
